(19) United States
(12) Patent Application Publication
(10) Pub. No.: US 2003/0066291 A1
(43) Pub. Date: Apr. 10, 2003

(54) Internally powered compact actuator for robotic applications

(76) Inventor: Claudio Filippone, College Park, MD (US)

Correspondence Address: CLAUDIO FILIPPONE, 8708 48th Place, College Park, MD, 20740, US

(21) Appl. No.: 10/265,149

(22) Filed: Oct. 7, 2002

Related U.S. Application Data
(60) Provisional application No. 60/326,992, filed on Oct. 5, 2001.

(51) Int. Cl. F01B 21/04; F01K 23/00; F02B 73/00

(52) U.S. Cl. 60/698

(57) ABSTRACT

Robotic, and Exoskeletal designs and applications may require a direct conversion of power in the form of electrical, hydraulic, or mechanical actuation. By utilizing actuators powered by a miniaturized power source located inside the actuator the normally cumbersome external systems for power generation and distribution are eliminated. In this invention a piston-cylinder assembly integrated concentrically inside the core of a special burner provides a controlled power-stroke to be utilized as the actuator for robotic and similarly actuated structures. Each actuator has its own fuel reservoir and can be operated independently of each other through an internal computer system, as well as the action of one or more self-powered actuator(s) can be controlled by an external computer so as to execute programmed routines involving several actuators simultaneously.

### BACKGROUND OF THE INVENTION

Micro Electro-Mechanical Systems (MEMS) contain extremely small mechanical elements, often integrated together with electronic processing circuitry. MEMS systems are measured in micrometers (microns), that is millionths of a meter. The diameter of human hair is about 100 microns. MEMS devices are manufactured in a similar fashion to computer microchips. The biggest advantage here is not necessarily that the system can be minuaturized, but rather that the lithographic techniques that now mass-produce thousands of complex microchips simultaneously can also be used to manufacture mechanical sensors and actuators. The draw-back of these devices or actuators is that they produce also miniaturized torque or forces. The main objective of the present invention is to merge some NEMS concepts of miniaturization into a device or actuator with macroscopic dimensions when compared to the MEMS device, but still miniaturized enough to provide a compact actuator. The resulting actuator utilizes microchips, sensors, and miniaturized actuated and controlled valves to drive relatively larger systems such as a gas, or a vapor turbine. The general dimensions of the Internally Powered Compact Actuator (IPCA) are similar to those of two soda-cans piled one on top of the other making it particularly interesting for exoskeletal or robotic actuation. However, applications of MEMS technology can push the envelope of the miniaturization of the IPCA to the limits of combustion in micro-combustion chambers. Actuators can be hydraulic, electric, pneumatic, magnetic and so forth. Generally their power source is outside the actuator, thereby forcing connection and distribution of power all around the exoskeletal or robotic application. The novelty proposed in the ICPA is the integration of a complete innovative plasma aided combustion system inside the core of the actuator itself.

### SUMMARY OF THE INVENTION

Robotic, and Exoskeletal designs may require a direct conversion of power by an actuator equipped with its own power plant for a more efficient conversion of the fuel energy directly into actuation power. The main objective of the Internally Powered Compact Actuator (IPCA) is to provide a reliable miniaturized fast-responding piston-cylinder assembly integrated concentrically inside a thermal-hydraulic system receiving energy from a plasma ionized and ignited fossil fuel burner. Heat from the products of combustion is instantaneously converted into mechanical actuation by injecting distilled water, or any fluid with proper thermal-physical properties, inside a closed loop high-pressure compact heat-exchanger in thermal contact with the products of combustion generated inside the burner. Subsequent to the distilled water injection high-pressure super heated steam expands almost instantaneously inside a spring-loaded piston inside a piston-cylinder assembly surrounded by the plasma-aided burner. Said piston generates a controlled stroke utilized as the actuator for robotic or exoskeletal structures.

This actuator generates the desired power level by regulating the amount of water injected inside the concentric heat exchanger in conjunction with the fuel-burning rate inside the plasma-aided burner. To minimize heat losses and maximize steam expansion rates, the actuator is surrounded by said concentric heat exchanger, and by a “thermal flywheel.” This results in an extremely compact heat-to-mechanical or electrical conversion system.

High-pressure steam drives the actuator in one direction while a spring drives it in the opposite direction resetting the original position of said piston. A computer controlled brake system connected to the actuator allows fine-tuning of the force applied by the actuator in both directions. Overall, the ionizing and igniting cold/hot plasma, the fuel vaporization and metering system, and the amount of water injected is controlled by a computerized controller linked to sensors for actuation. Signals fed-back and translated from movements of the various robotic or exoskeleton's components activate fuel vaporization and metering with subsequent plasma ignition generating nearly instantaneous steam production at the desired rate, thereby converting these signals into movement of the actuator with the desired power level and speed.

The burner is formed by rotating components allowing a fraction of the rotating energy of these components to be converted to electrical power by means of an electric alternator recharging an internal battery powering the computer systems and all sensors. Additionally, and depending on design requirements, the IPCA alternator can be configured with an alternator dimensioned to provide additional electric power at different voltages output to external electric loads.

A “thermal flywheel” located inside said concentric heat exchanger is made of materials with high specific heat directly exposed to the flame generated by the fossil fuel combustion (i.e. JP-8). During the IPCA idling conditions (minimum electric demand) a desired heat charge is accumulated in the “thermal flywheel” by burning a minimum amount of fuel only to keep this thermal energy reservoir charged. When an instantaneous increase of steam pressure is required by injecting more water (or other fluids, including refrigerant), the thermal reservoir responds rapidly to a peak in demand, while the burner might take a few hundreds of milliseconds to throttle up. In this manner, a few milliseconds after the desired amount of liquid water is injected, vapor pressure causes the IPCA alternator to accelerate while the piston executes a power stroke with a proportional force. This situation might occur for a sudden increase in electric or mechanical power demand as it could happen for a robotic application where the robotic device is challenged by obstacles (i.e. stair climbing, difficult terrain) and the robotic energy consumption increases dramatically.

After having expanded inside the piston-cylinder assembly, the resulting exhausting vapor is vented inside another concentric heat exchanger cooled by the burner intake air and forming the radiator of the vapor cycle.

### BRIEF DESCRIPTION OF THE DRAWINGS

FIG. 1; Is a schematic representation of the IPCA block-diagram with flow lines indicating the combustion gases circuit and the vapor-cycle circuit formed by a closed loop integrating the working fluid tank, sealed hydraulic connections, pump(s) etc..

FIG. 2; Is a schematic representation of the IPCA internal structures with flow lines indicating mainly the fossil fuel -burning cycle including fuel tank, pump, electric alternator, vapor turbine, and gas turbine all self contained inside the IPCA structure.

FIG. 3; Is a schematic representation of a complete IPCA showing the piston-cylinder assembly positioned in the core of the burner and surrounded by the special compact heat exchangers.

### DESCRIPTION OF THE PREFERRED EMBODIMENTS

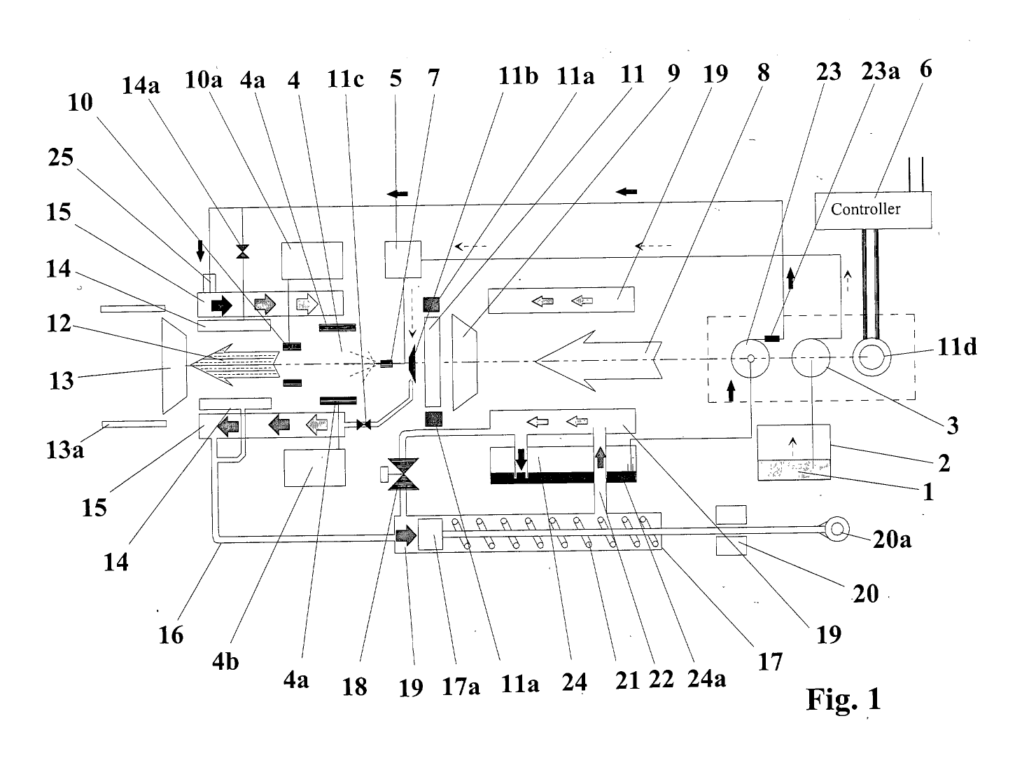

The working principles of the IPCA are described in FIG. 1-3. In FIG. 1 the IPCA burner and actuator unit are described. From the burner side the fuel tank 2 contains fossil fuel 1 (i.e. JP8), pressurized for injection via fuel pump 3. The injection of fuel 1 inside burner activator 4 is achieved by piezoelectrically cold vaporizing the fuel in an amount desired. Alternatively, another method to vaporize fuel 1 is achieved by a thermal vaporizer 5 containing an electrical heater (not shown in FIG. 1) controlled by computerized controller 6 and activated only during start-up of the ICPA unit, after start-up the thermal vaporizer is heated by the exhaust combustion gases 12. Therefore, fuel pump 3 pressurizes fuel 1 into a thermal or piezoelectric system 5 able to vaporize and meter said fuel 1 on demand. After vaporization fuel 1 is injected via injector 7 inside an activating chamber 4 wherein a series of symmetrical electrodes 4a are positioned so as to ionize the air-fuel mixture and electro-statically maintain said mixtures away from the surfaces lining the ionizing chamber 4. The high voltage generator and controller 4b for the cold plasma discharge are powered initially by a start-up battery. Once the unit is operating, the power for the various electronic subsystems is provided by the internal alternator 11, driven by controller 6. Ionized fuel 1 mixed with air 8, compressed by a compressor turbine 9, is forced into a series of hot plasma discharging electrodes 10 controlled by the hot plasma generator 10a. At this point a highly efficient combustion takes place inside the burner generating hot combustion products 12. These combustion products 12 expand through a gas turbine 13 mechanically connected to said alternator system 11, and said compressor turbine 9. While the combustion products 12 transit inside the burner they release heat to a thermal flywheel 14 exposed to the flame of the burner and to a compact heat exchanger 15 lining and surrounding the burner. Said thermal flywheel 14 is activated by injecting water (or other fluids) through valve 14a. Water circulates in the closed-loop inside said compact heat exchangers 15, and said thermal flywheel 14.

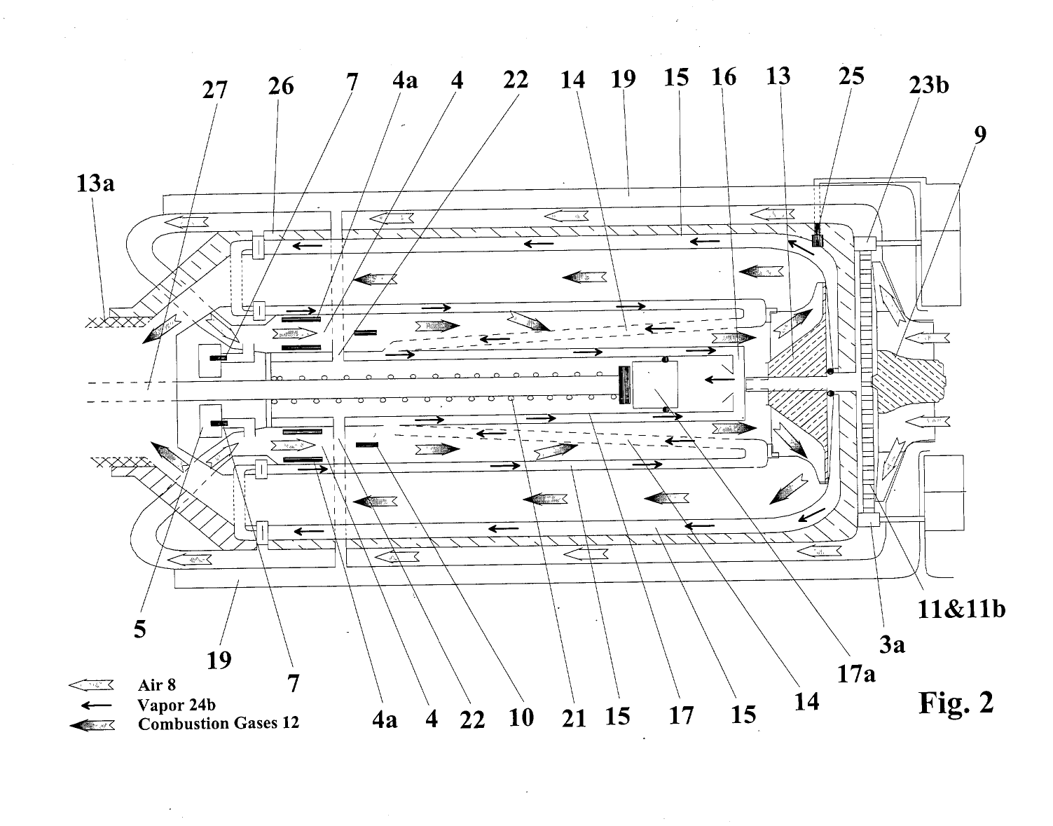

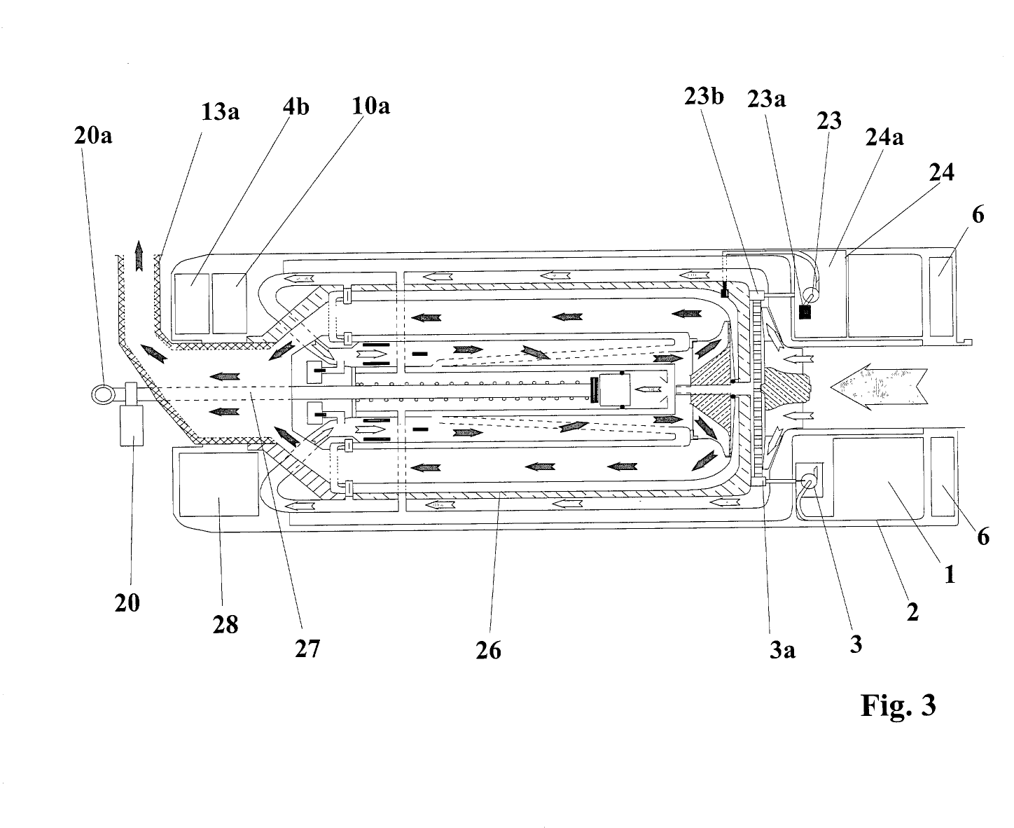

From the vapor cycle side, said water (24a FIG. 3) receives a heat addition process while transiting inside the compact heat exchanger 15, or 14, or both of them at the same time. After the heat addition processes water flashes to superheated steam and through hydraulic connection 16 it expands inside piston-cylinder assembly 17. Super heated steam is also allowed to expand through a vapor turbine 11b through a vapor valve 11c controlled and actuated by controller 6. By venting the superheated steam inside the cooling heat-exchanger 19 controlled and actively actuated exhaust vapor valve 18 allows partial regulation of pressure inside said piston-cylinder assembly 17. Once pressure develops in the space 19a above the piston 17a the piston 17a executes a power stroke with a force modulated by the pressure of steam, the regulation of valve 18, the action of brake system 20, and the amount of fuel and water injected and originating the power stroke. Said force is applied to the load through mechanical coupler 20a. The position of piston 17a is determined by the action of spring 21, and the opening/closing of valve 18. If a full stroke is developed the exhausting steam is vented into the cooling heat exchanger 19 through hydraulic connection 22 which acts as an exhaust vapor-venting channel. If a partial stroke is developed the exhausted steam is allowed to vent into cooling heat exchanger 19 through valve 18. Cooling heat exchanger 19 is exposed to the large mass flow rate of the burner intake air 8 on one side while it is thermally insulated from the expanding steam. Once inside the cooling heat exchanger 19 the exhausted steam condenses back to liquid. Water pump 23 is actively controlled and actuated by controller 6 which regulates the pump capacity through throttling device 23a. Water pump 23 extracts liquid water (or any proper working fluid) from water tank 24, and after pressurizing it to a level depending on pump capacity and the position of the throttling device 23a, it injects the water into the compact heat exchanger 14 through one or more check valve(s) 25. Water can also be injected into the thermal flywheel 14 through valve 14a. Components 14a, water pump 23, throttling device 23a, valve 18, and brake system 20 can be actuated and controlled by controller 6. Water pump 23 and fuel pump 3 are driven by a gear system 23b and 3a (FIG. 2) mechanically connected to vapor turbine 11b. The alternator system 11 is formed by a rotating disk with permanent magnets magnetically coupled with stationary coils 11a. Said rotating disk is mechanically linked or embedded with vapor turbine 11b and the gas turbine 13. Similarly electric power can be produced through a dynamo 11d linked to the shaft connected to said vapor turbine 11b. The alternator system 11, or the dynamo 11d field and ouput, is controlled by controller 6 so as to provide a constant voltage output to external electric loads, and to the start-up battery 28 (FIG. 3).

In FIG. 2 the cross section of the internal components of the burner is shown with numbering consistent with FIG. 1. From left to right the air compressor turbine 9 compresses air 8 inside a jacket like structure preferentially formed by concentric cylinders surrounding the entire unit. This jacket-like structure is responsible for the cooling heat transfer mechanism with cooling heat exchanger 19. Air 8 travels inside said jacket-like structure, it cools down cooling heat exchanger 19 and enters the burner (from right to left now) after a series of u-turn sealed tubing disposed radially along the circumference of the unit. The thermal, or piezoelectric, vaporizer system 5 through one or more injectors 7 allows fuel to be mixed with the incoming air 8. This mixture undergoes cold corona discharge (cold plasma) via electrodes 4a resulting in an ionized mixture in region 4 of the burner. After ionization the air-fuel mixture undergoes a plasma flame (hot plasma) via electrodes 10 and a highly efficient combustion occurs. Combustion products 12 now travel inside the combustion chamber surrounded internally and externally by the compact heat exchanger 15. While transiting inside the combustion chamber combustion gases 12 also go through the thermal flywheel 14 prior to their expansion into gas turbine 13. While expanding in said gas turbine 13 the combustion gases make a u-turn and while traveling inside this redundant jacket-like structure they release heat into compact heat exchanger 15 which is still surrounding said jacket-like structure. Finally said combustion gases 12 exhaust at the exhaust muffler 13a to the left of FIG. 2. In the closed-loop vapor cycle water (or any proper fluid) is injected inside the compact heat exchanger 15 via one or more injector(s) 25. Water can also be injected directly into thermal flywheel 14 (not shown in this drawing) for boosted power output. Once water is injected via injector 25 it flashes to steam due to heat transfer with the surfaces of compact heat exchanger 15 exposed to the combustion gases 12 on one side and thermally insulated from the intake air 8 through a thermal barrier 26 made of low thermal conductivity materials on the opposite side. This newly formed vapor 24b travels inside compact heat exchanger 15 (initially from left to right) and at the end of the first path it makes a u-turn through hydraulic connections 24c, thereby re-entering the burner structure. Another compact heat exchanger 15 is formed in the core of the burner by essentially concentric cylinders sealed in a manner to create a closed-loop circuit for the water. Vapor 24b is now exposed to heat transfer on all surfaces of the compact heat exchanger 15. In this configuration vapor 24b enters the thermal flywheel 14. Alternatively vapor 24b can by-pass the thermal flywheel 14 and access it only when commanded by controlled valve 14a (shown in FIG. 1). Superheated vapor 24b is now accessing the piston-cylinder assembly 17 and through hydraulic connections 16 it expands inside the piston-cylinder assembly generating the power stroke. The force exerted by the piston on the connecting rod 27 is proportional to the amount of steam generated, the amount of fuel injected (heat), the adjustments of controlled valve 18 and the action of brake system 20 (shown in FIG. 3). If the stroke is completed to the whole length, exhausting steam is allowed to vent for condensation through exhaust vapor venting channels 22. If the piston is stopped anywhere in the middle of the stroke whole length steam, or the exhausted vapor, is allowed to vent through controlled vapor exhaust valve 18 into the cooling heat exchanger 19. Once inside this cooling heat exchanger 19 the exhaust vapor condenses back to liquid thanks to the cooling action of the burner intake air 8, thereby completing the vapor cycle.

In FIG. 3, a more complete IPCA unit is shown. Fuel tank 2 and fuel pump 3 are positioned above the air intake inlet. However, this position is not a limitation since fuel tanks and pumps can be positioned anywhere in the IPCA unit. Therefore, the position of these sub-components is only indicative as well as the scale of said water and fuel tanks and pumps. Water tank 24, water 24a and water pump 23a are also positioned above the burner intake air inlet. Water pump 23 and fuel pump 3 are positive displacement pumps geared and powered through gear system 23b and 3a respectively. Start-up battery 28 is positioned near the hot and cold plasma generators and controllers 4b and 10a, while the computerized controller unit 6 can be positioned on a printed circuit shaped like a ring surrounding the burner intake air inlet, thereby receiving cooling from the intake air 8. The computerized controller unit 6 by controlling the alternator system 11 or the dynamo 11d (FIG. 1) also provides rectified voltage output for external electrical loads. External connections allow to over-ride controller 6 so as to control the operation of multiple IPCA through a central computer outside the IPCA unit. This concludes the description of the Internally Powered Compact Actuator unit.

What is claimed is:

1. An internally powered compact actuator powered by fossil fuels configured to produce electric and mechanical energy, the system comprising:
At least one air inlet;
At least one fuel pump;
At least one injector;
At least one burner activator chamber;
At least one combustion chamber;
A thermal hot or cold fuel vaporizing and metering injection system;
A computerized controller;
A series of symmetrical electrodes;
A high-voltage generator and controller for cold plasma discharge
An internal alternator, driven by a vapor turbine and controlled by said computerized controller;
At least one compressor turbine;
A high-voltage generator and controller for hot plasma
At least one gas turbine;
A thermal flywheel;
A compact heat exchanger;
A working fluid in a closed loop;
At least one actively controlled and actuated working fluid pump;
A spring loaded piston-cylinder assembly;
A controlled and actively actuated vapor exhaust valve;
A controlled and actively actuated vapor valve;
A cooling heat-exchanger;
A mechanical coupler outputting force from the actuator;
An electric output;
An electric input for control purposes;
A working fluid storage tank;
An actively controlled brake system;
At least one electric alternator;
At least one vapor turbine;
At least one combustion gases outlet.

2. An internally powered compact actuator powered by fossil fuels as defined in claim 1, wherein said thermal vaporizer contains an electrical heater.

3. An internally powered compact actuator powered by fossil fuels as defined in claim 1, wherein said thermal vaporizer contains a piezoelectrically cold fuel vaporizing system;

4. An internally powered compact actuator powered by fossil fuels as defined in claim 1, wherein said thermal vaporizer, after start-up, is heated by the exhaust combustion gases.

5. An internally powered compact actuator powered by fossil fuels as defined in claim 1, wherein said symmetrical electrodes are positioned so as to ionize-the air-fuel mixture and electro-statically maintain said mixtures away from the surfaces lining said ionizing chamber.

6. An internally powered compact actuator powered by fossil fuels as defined in claim 1, wherein said gas turbine is mechanically connected to said alternator system, and said compressor turbine.

7. An internally powered compact actuator powered by fossil fuels as defined in claim 1, wherein said thermal flywheel is exposed to the flame of the burner, and is hydraulically connected to a compact heat exchanger.

8. An internally powered compact actuator powered by fossil fuels as defined in claim 1, wherein said compact heat exchanger is lining and surrounding the burner.

9. An internally powered compact actuator powered by fossil fuels as defined in claim 1, wherein said controlled and actuated exhaust vapor valve allows partial regulation of pressure inside a piston-cylinder assembly.

10. An internally powered compact actuator powered by fossil fuels as defined in claim 1, wherein said piston executes a power stroke with a force modulated by:
the pressure of steam;
the regulation of said controlled and actuated vapor exhaust valve;
the action of a controlled and actuated brake system;
the amount of fuel, and water injected.

11. An internally powered compact actuator powered by fossil fuels as defined in claim 1, wherein said piston can move from an initial position to its full excursion by venting exhaust vapor into a cooling heat exchanger through a vapor venting channel.

12. An internally powered compact actuator powered by fossil fuels as defined in claim 1, wherein said piston can move from an initial position to any intermediate positions by venting exhaust vapor into said cooling heat exchanger through said controlled and actuated exhaust vapor valve.

13. An internally powered compact actuator powered by fossil fuels as defined in claim 1, wherein said cooling heat exchanger condenses the working fluid to liquid via heat transfer with to the burner intake air.

14. An internally powered compact actuator powered by fossil fuels as defined in claim 1, wherein said water pump extracts liquid water from a water tank, and pressurizes it to a level depending on pump capacity and the position of a throttling device located in the suction or discharge of said water pump.

15. An internally powered compact actuator powered by fossil fuels as defined in claim 1, wherein said water pump and said fuel pump are driven by a gear system mechanically linked to said vapor turbine.

16. An internally powered compact actuator powered by fossil fuels as defined in claim 1, wherein said alternator system for electric power production is formed by a rotating disk with permanent magnets magnetically coupled with stationary coils.

17. An internally powered compact actuator powered by fossil fuels as defined in claim 1, wherein said rotating disk is mechanically linked or embedded with said vapor turbine and said gas turbine.

18. An internally powered compact actuator powered by fossil fuels as defined in claim 1, wherein said electric power production system can be produced through a dynamo linked to the shaft connected to said vapor turbine.

19. An internally powered compact actuator powered by fossil fuels as defined in claim 1, wherein said electric power production system in the form of said alternator or dynamo is controlled by said computerized controller.

20. The method of producing electrical and mechanical energy through an internally powered compact actuator utilizing fossil fuels the system comprising:
At least one inlet;
At lest one Outlet;
At least one vapor turbine;
At least one gas turbine;
At least one electric power production system;
A fossil fuel storage tank;
A fossil fuel vaporizing and metering system;
A working fluid contained in a closed loop;
Means to superheat said working fluid in a closed loop;
Means to condensate said working fluid in a closed loop;
At least one piston-cylinder assembly;
Means to modulate the force exerted by said piston of said piston-cylinder assembly;
At least one mechanical coupler;
At least one electric power output;
A series of actuated and controlled valves;
A series of electrodes to ionize and ignite said fossil fuel;
A computerized control system;
